(19) United States
(12) Patent Application Publication
(10) Pub. No.: US 2022/0403139 A1
(43) Pub. Date: Dec. 22, 2022

(54) HIGH SOLIDS PIGMENTED LATEX COMPOSITION COMPRISING A VINYL ACETATE ETHYLENE DISPERSION

(71) Applicant: WACKER CHEMIE AG, Munich (DE)

(72) Inventors: Lisa KELLY, Fleetwood, PA (US); Timothy RUDOLPH, Zionsville, PA (US)

(73) Assignee: Wacker Chemie AG, Munich (DE)

(21) Appl. No.: 17/772,297

(22) PCT Filed: Oct. 29, 2019
(86) PCT No.: PCT/US2019/058542

§ 371 Date: Apr. 27, 2022

(51) Int. Cl. C08K 5/103; C08K 3/013

(52) U.S. Cl. CPC C08K 5/103; C08K 3/013

(57) ABSTRACT

A pigmented latex composition and uses for the same. The pigmented latex composition has a solids content in the range from 60 wt % to 95 wt % including a vinyl acetate ethylene copolymer dispersion (VAE dispersion) and a plasticizer. The pigmented latex composition further includes one or more plasticizers out of the group of polyethylene glycol diesters with 3 to 10 ethylene glycol units of C1-C10 alkyl carboxylic acids, wherein the carboxylic acids are identical or different and being branched or unbranched alkyl carboxylic acids.

### FIELD OF THE INVENTION

The invention is directed to a high solids pigmented latex composition including a vinyl acetate ethylene dispersion (VAE dispersion) and a plasticizer. More particularly, the present invention is directed to a high solids pigmented latex compositions for caulks and mastics having improved performance, containing a vinyl acetate ethylene dispersion and a polyethylene glycol ester plasticizer.

### BACKGROUND OF THE INVENTION

High solids pigmented latex compositions such as mastic and caulking compositions are used in a wide variety of applications to seal and protect architectural material substrates and to seal and protect joints and other openings in architectural materials. They are used in both interior and exterior applications, and in both cases are exposed to conditions such as moisture, sunlight, temperature variations, etc. that require such compositions to have a balance of properties enabling them to perform their intended functions for extended periods of time. Typically, mastics and caulks are fluid or semi-fluid compositions having a solids content of about 60 weight percent or more. They should have permanent low temperature flexibility when cured, particularly in the case of mastic compositions intended for exterior application. Both mastics and caulks should have sufficient wetting ability to readily wet, cover and adhere to even the most hydrophobic architectural substrates such as polyurethane, ethylene-propylene-diene interpolymer materials, and the like. Very low residual surface tack is generally required in cured mastics and caulks, and they should quickly become non-tacky shortly after application to prevent adherence of dust, dirt or other materials.

Mastics are frequently used in combination with scrims for heating, ventilating and air conditioning applications to provide permanent, air tight, flexible, and weather resistant repairs and installations on air ducts, thermal insulation, and crawl spaces. Typical uses included sealing duct leaks in homes, apartments, offices, hospitals, high rises, and government and military buildings, to improve comfort and indoor air quality and to save energy.

Caulks are flexible sealing compounds used to close up gaps in buildings and other structures against water, air, dust, insects, or as a component in firestopping structures.

U.S. Pat. No. 5,349,009 describes a water-based construction adhesive mastic said to have improved performance in open time requirements, freeze-thaw-stability and water resistance. The mastic is based on a combination of VAE copolymer emulsion and VAC homopolymer emulsion.

U.S. Pat. No. 8,088,854 claims a polymer composition comprising a vinyl acetate polymer and a di-butyl terephthalate plasticizer for the use in adhesive compositions.

U.S. Pat. Appl. 2012/0234490 discloses a pigmented latex composition based on an APE-free VAE dispersion for the use in caulks and mastics.

Traditional binders for mastics and caulks have typically employed alkylphenol ethoxylate (APE) surfactants to maintain polymer dispersion stability. More recently, however, regulatory trends have restricted the use of such surfactants, which are suspected to carry health risks. Thus, mastics and caulks using binder dispersions free of alkylphenol ethoxylates would be of commercial interest.

Vinyl acetate ethylene dispersions have been used in blends with acrylic polymers to achieve performance requirements such as those found in ASTM C834. Benzoate plasticizers have been commonly used in the industry to depress the glass transition temperature “Tg” of the polymer binder and increase flexibility and adhesion of the resulting caulk or mastic produced with vinyl acetate ethylene. However, the inclusion of benzoate plasticizer in the caulk formulations is not efficient enough to allow the resulting caulk to consistently meet the requirements of ASTM C834.

In order to overcome the deficiencies associated with the use of benzoate plasticizers, phthalate plasticizers were used in the industry to allow the use of vinyl acetate ethylene as a single binder. The use of phthalate plasticizers allowed the resulting materials to meet the requirements of ASTM C834, including the mandrel bend test. Both approaches have significant disadvantages; acrylic binders are expensive and phthalate plasticizers are undesirable in the industry for environmental reasons. Accordingly, there is a need in the industry for vinyl acetate ethylene compositions that are capable of repeatedly meeting the requirements of ASTM C834, while reducing cost and with more environmentally friendly plasticizers.

### SUMMARY OF THE INVENTION

It has surprisingly been found that the introduction of a polyethylene glycol diester plasticizer enabled the use of a vinyl acetate ethylene dispersion as one hundred percent of the binder in formulated caulks, while reducing the amount of vinyl acetate ethylene copolymer needed in the formulation. Additionally, it has been found that the inclusion of a polyethylene glycol diester plasticizers suppresses the Tg of the polymer binder and produces a caulk that consistently meets the requirements of ASTM C834, including the mandrel bend test.

The invention provides a pigmented latex composition having a solids content in the range from 60 wt % to 95 wt % comprising a vinyl acetate ethylene copolymer dispersion (VAE dispersion) and a plasticizer characterized in that the pigmented latex composition comprises one or more plasticizers from the group of polyethylene glycol diesters with 3 to 10 ethylene glycol units of C1-C10 alkyl carboxylic acids wherein the carboxylic acids are identical or different and being branched or unbranched alkyl carboxylic acids.

### DETAILED DESCRIPTION OF THE PREFERRED EMBODIMENTS

The inventors have found that caulk and mastic compositions using VAE dispersions and traditional plasticizers such as benzoate ester plasticizer are not sufficient to provide a caulk or mastic formulation capable of passing the requirements of ASTM C834, including the mandrel bend test. The inventors have found that it is possible to obtain superior performance consistently meeting the requirements of ASTM C834 by using vinyl acetate ethylene (VAE) binder dispersions in combination with polyethylene glycol diester plasticizers.

The invention provides compositions comprising pigments and/or other fillers admixed with aqueous dispersions of VAE copolymer resins with one or more plasticizers from the group of polyethylene glycol diesters, wherein the glycol has 3 to 10 ethylene glycol units, with C1-C10 alkyl carboxylic acids wherein the carboxylic acids are identical or different and are branched or unbranched alkyl carboxylic acids. The compositions have a high solids content, for example solids contents of at least 60 wt %, or at least 65 wt %, or at least 70 wt %. The solids content will typically be at most 95 wt %, or at most 90 wt %. The compositions also comprise one or more plasticizers and one or more pigment/fillers and/or dispersants. As used herein, the term “solids content” refers to the total amount of pigment/filler, binder resin polymer, plasticizer, dispersant and surfactant in the composition. Each of the main components of the compositions will now be described, as well as methods of formulating mastics and caulks according to the invention.

### Polymer Binder

Polymeric binders useful for making mastics and caulks according to the invention comprise vinyl acetate and ethylene optionally copolymerized with one or more unsaturated carboxylic acid monomers. Vinyl acetate units constitute at least 60 wt %, or at least 65 wt %, or at least 70 wt %, or at least 75 wt % of the dispersed polymer. They constitute at most 99 wt %, or at most 95 wt %, or at most 90 wt %, or at most 85 wt % of the dispersed polymer. Ethylene units constitute at least 1 wt %, or at least 5 wt %, or at least 10 wt %, or at least 15 wt % of the dispersed polymer, and constitute at most 40 wt %, or at most 30 wt %, or at most 25 wt %, of the dispersed polymer. Using an appropriate ratio of ethylene to vinyl acetate provides a binder with a Tg that results in good elasticity and flexibility. Typically, suitable Tg values are in a range from −20° C. to 12° C. The glass transition temperature Tg of the polymers is determined using a Mettler-Toledo DSC1 dynamic differential scanning calorimeter (open cup) at a heating rate of 10 K/min. The mid-point of the glass transition is evaluated in the 2nd heating cycle. Selection of the monomers and/or selection of the proportions by weight of the comonomers proceeds such that the above-mentioned glass transition temperatures Tg are achieved. The Tg can also be calculated approximately in advance using the Fox equation. According to Fox T. G., Bull. Am. Physics Soc. 1, 3, page 123 (1956): 1/Tg=x1/Tg1+x2/Tg2+ . . . +xn/Tgn, where xn represents the mass fraction (% w/w/100) of the monomer and Tgn is the glass transition temperature in Kelvin of the homopolymer of the monomer n. Tg values for homopolymers are listed in the Polymer Handbook 2nd Edition, J. Wiley & Sons, New York (1975).

The amount of the optional ethylenically unsaturated carboxylic acid monomer units in the polymeric binder should be at least 0.75 wt %, or at least 1.0 wt %, or at least 1.25 wt %, or at least 1.5 wt %, and may be as high as 5 wt %, or as high as 4 wt %, or as high as 3 wt %, or as high as 2 wt %.

Examples of suitable unsaturated carboxylic acid monomers include ethylenically unsaturated C3-C8-monocarboxylic acids such as acrylic acid, methacrylic acid and crotonic acid, ethylenically unsaturated C4-C8-dicarboxylic acids such as maleic acid, fumaric acid, and itaconic acid, the monoamides thereof and the monoesters thereof with C1-C12-alkanols, preferably C1-C4-alkanols, such as monomethyl maleate and mono-n-butyl maleate. Preferred are acrylic acid, methacrylic acid, itaconic acid, crotonic acid and maleic acid.

Unsaturated sulfonic acids may optionally also be included in the monomer composition. Suitable unsaturated sulfonic acid monomers include 2-acrylamido-2-methylpropane sulfonic acid and salts thereof, as well as vinylsulfonic acid and salts thereof. Typical salts include potassium, sodium and ammonium salts. One specific suitable example is available commercially from Lubrizol Corporation of Wickliffe, Ohio under the name AMPS® 2403. Sulfonic acid/salt monomer units constitute from 0.1 to 5.0 wt %, more typically 0.2 to 1.0 wt %, of the polymeric binder. Preferred are ethylenically unsaturated sulfonic acids having 2-8 carbon atoms, such as vinylsulfonic acid, 2-acrylamido-2-methylpropanesulfonic acid, 2-acryloyloxyethanesulfonic acid and 2-methacryloyloxyethanesulfonic acid, 2-acryloyloxy- and 3-methacryloyloxypropane sulfonic acid, vinylbenzenesulfonic acid. In addition to or instead of these acids, it is also possible to use the salts thereof, preferably the alkali metal or ammonium salts thereof, more preferably the sodium salts thereof, such as, for example, the sodium salts of vinylsulfonic acid and of 2-acrylamidopropanesulfonic acid.

In some embodiments the binder may include 0 to 30 wt % of other comonomer units from the group consisting of vinyl chloride, vinyl esters and (meth)acrylic acid esters. Suitable other vinyl esters are those of carboxylic acids with 3 to 12 carbon atoms such as vinyl propionate, vinyl butyrate, vinyl 2-ethylhexanoate, vinyl laurate, 1-methyl vinyl acetate, vinyl pivalate and vinyl esters of α-branched monocarboxylic acids with 9 to 13 carbon atoms, such as VeoVa™9, VeoVa™10, or VeoVa™11 (available from Hexion Specialty Chemicals, Inc., Columbus, Ohio). Suitable methacrylic or acrylic acid esters are esters of straight-chain or branched alcohols having 1 to 15 C atoms, for example methyl acrylate, methyl methacrylate, ethyl acrylate, ethyl methacrylate, propyl acrylate, propyl methacrylate, butyl acrylate (n-, iso- and tert-), n-butyl methacrylate, 2-ethylhexyl acrylate and norbornyl acrylate. Methyl acrylate, methyl methacrylate, butyl acrylate and 2-ethylhexyl acrylate are preferred.

If appropriate in a particular application, auxiliary monomers may also be copolymerized. The amount will typically be from 0.01 wt % to 10 wt %, typically at least 0.05 wt %, when present, based on the total weight of the polymer. Examples of auxiliary monomers are ethylenically unsaturated carboxamides and carbonitriles. Further examples are precrosslinking comonomers, such as polyethylenically unsaturated comonomers, for example divinyl adipate, diallyl maleate, allyl methacrylate or triallyl cyanurate, or postcrosslinking comonomers, for example acrylamidoglycolic acid (AGA), methyl methylacrylamide glycolate (MAGME), N-methylolacrylamide (NMA), N-methylolmethacrylamide (NMMA), N-methylolallyl carbamate, alkyl ethers, such as the isobutoxy ether, or esters of N-methylolacrylamide, of N-methylolmethacrylamide and of N-methylolallyl carbamate. Examples are also epoxide-functional comonomers, such as glycidyl methacrylate and glycidyl acrylate. Further examples are silicon-functional comonomers, such as acryloyloxypropyltri(alkoxy)- and methacryloyloxypropyl tri(alkoxy)silanes, vinyltrialkoxysilanes and vinylmethyldialkoxysilanes, preferably with C1 to C3 alkoxy groups such as methoxy or ethoxy.

If present, polyethylenically unsaturated comonomers such as mentioned above will constitute in total from about 0.01 wt % to about 1 wt %. Typically, the amount will be at most 0.5 wt %, or at most 0.2 wt %, or at most 0.1 wt %. The presence of a polyunsaturated comonomer is not beneficial in all embodiments of the invention; thus, in some embodiments such monomers are to be excluded.

Nonlimiting examples of suitable binder polymers are: copolymers of vinyl acetate with from 1 to 40% by weight of ethylene; copolymers of vinyl acetate with from 1 to 40% by weight of ethylene and from 1 to 50% by weight of one or more further comonomers from the group consisting of vinyl esters having 3 to 12 C atoms in the carboxyl radical, such as vinyl propionate, vinyl laurate, vinyl esters of alpha-branched carboxylic acids having 9 to 12 C atoms, such as VeoVa9®, VeoVa10®, VeoVa11®; copolymers of vinyl acetate, from 1 to 40% by weight of ethylene and preferably from 1 to 60% by weight of (meth)acrylates of straight-chain or branched alcohols having 1 to 15 C atoms, in particular butyl acrylate or 2-ethylhexyl acrylate; and copolymers comprising from 30 to 75% by weight of vinyl acetate, from 1 to 30% by weight of vinyl laurate or vinyl esters of an alpha-branched carboxylic acid having 9 to 12 C atoms, and from 1 to 30% by weight of (meth)acrylates of straight-chain or branched alcohols having 1 to 15 C atoms, in particular methyl methacrylate, butyl acrylate or 2-ethylhexyl acrylate, which also contain from 1 to 40% by weight of ethylene; copolymers comprising vinyl acetate, from 1 to 40% by weight of ethylene and from 1 to 60% by weight of vinyl chloride; it is also possible for the polymers to contain the above-mentioned optional monomers or auxiliary monomers in the amounts mentioned, provided that the amount of monomers sum to 100 wt %.

Nonetheless, depending on the specific needs of a given application, it may in some cases be advantageous to exclude certain monomers in making the polymeric binder. In other cases, these monomers may be included up to a limit of 1.0 wt % of the polymeric binder. The excluded or limited monomers may include any one or more of the following: N—(C₁₋₄) alkylol (meth)acrylamides (e.g., N-methylol acrylamide); i-butoxy methylacrylamide; acrylamidoglycolic acid; acrylamidobutyraldehyde; dialkyl acetals of acrylamidobutyraldehyde; glycidyl-containing compounds (e.g., glycidyl(meth)acrylate, triglycidyl isocyanurate, etc.); ethylenically unsaturated phosphates, phosphonates or sulfates; ethylenically unsaturated silicon compounds; (meth)acrylamide or N-substituted meth)acrylamides; (meth)acrylic esters; vinyl or other alkenyl ethers; acrylonitrile; butadiene; styrene; vinyltoluene; divinyl benzene and/or other olefinically unsaturated hydrocarbons other than ethylene; halogenated monomers (e.g., vinyl chloride); and esters of allyl alcohol.

In particular, it has been found that including N-methylol acrylamide increases the potential for pigment agglomeration/destabilization, and therefore this monomer is preferably excluded. An additional reason to exclude this monomer is its propensity for producing formaldehyde, a toxic material. Other N-methylol-containing monomers may also share this problem. Therefore, in some embodiments of the invention, the VAE polymeric binder does not contain units of NMA or any other N-methylol-containing monomer, or any other monomer that produces formaldehyde either in the coating composition or on a treated substrate. For the same reason, it may further be desired to exclude urea-formaldehyde, glycol uril, and other formaldehyde-generating moieties in the binder, and preferably in the entire coating composition. Thus, in some embodiments, the composition is free of formaldehyde-generating moieties.

To further avoid formaldehyde formation, it is also preferred that the binder copolymer be prepared by initiating the vinyl acetate ethylene dispersion polymerization with an initiator that does not contain formaldehyde-producing moieties, as opposed to using the more typical redox pair initiator employing formaldehyde-producing sodium formaldehyde sulfoxylate (SFS) or zinc formaldehyde sulfoxylate as the reducing agent. In general, suitable non-formaldehyde generating reducing agents for redox pairs include, as non-limiting examples, those based on ascorbic, bisulfite, erythorbate or tartaric chemistries as known in the art, and the commercial reducing agent known as BRUGGOLITE® FF6M manufactured by Bruggeman Chemical of Heilbronn, Germany. Non-redox initiators may also be used, such as persulfates, peroxides and azo-type initiators, all of which are well known in the art.

Preparation of the binder copolymer is accomplished by an emulsion polymerization process, typically at a temperature of 30 C. to 100 C and at a pressure typically from 5 bar to 100 bar.

The polymerization is initiated with the water-soluble initiators or redox initiator combinations customary for emulsion polymerization. Examples of water-soluble initiators are the sodium, potassium and ammonium salts of peroxodisulfuric acid, hydrogen peroxide, tert-butyl peroxide, tert-butyl hydroperoxide, potassium peroxodiphosphate, tert-butyl peroxopivalate, cumyl hydroperoxide, isopropylbenzyl monohydroperoxide, azobisisobutyronitrile. The initiators are used in general in an amount of from 0.1 to 2.0 wt %, preferably from 0.1 to 1.0 wt %, based in each case on the total weight of the monomers.

Redox initiators used are combinations of said initiators in combination with reducing agents. Suitable reducing agents are the sulfites and bisulfites of the alkali metals and of ammonium, for example sodium sulfite, and ascorbic acid. The amount of reducing agent is in general from 0.1 to 2.0 wt %, preferably from 0.1 to 1.0 wt %, based in each case on the total weight of the monomers.

For controlling the molecular weight, regulating substances can be used during the polymerization. If regulators are used, they are usually employed in amounts of from 0.01 to 5.0 wt %, based on the monomers to be polymerized and are metered separately or premixed with reaction components. Examples of such substances are n-dodecyl mercaptan, tert-dodecyl mercaptan, mercaptopropionic acid, methyl mercaptopropionate, isopropanol and acetaldehyde.

The monomers can all be initially introduced for the preparation of the dispersion (batch process), or a part of the monomers is initially introduced, and the remainder is metered (semi-batch process). The resultant aqueous dispersions obtainable have a solids content of from 30 to 75 wt %, preferably from 50 to 60 wt %.

### Pigments

The mastic and caulk compositions of the invention may include relatively high levels of pigments. As used herein, the term “pigment” includes any solid particulate material commonly used to provide color (especially white) or to act as a filler. Suitable pigments and/or fillers may include, for example, alkaline earth metal sulfates or carbonates, such as, for example, barites, calcium carbonate, calcite and magnesium carbonate; silicates, such as, for example, calcium silicates, magnesium silicates, and talc; metal oxides and hydroxides, such as, for example, titanium dioxide, alumina and iron oxides; diatomaceous earth; colloidal silica; fumed silica; carbon black; white carbon black; nutshell flour; natural and synthetic fibers (especially plaster fibers); and scrap or recycled plastics in the form of dust, flakes or flour; hollow or solid ceramic, glass or polymeric microspheres. The amount of pigments is preferably in a range from 30 to 50 wt %, based on the weight of the pigmented latex composition.

### Plasticizers

The high solids pigmented latex compositions include one or more plasticizers from the group of polyethylene glycol diesters having 3 to 10 ethylene glycol units with C1-C10 alkyl carboxylic acids wherein the carboxylic acids are identical or different and are branched or unbranched alkyl carboxylic acids. Preferred are the polyethylene glycol diesters having 3 to 10 ethylene glycol units with C6-C10 alkyl carboxylic acids. Most preferred are the polyethylene glycol diesters having 3 to 6 ethylene glycol units with C6-C10 alkyl carboxylic acids. The amount of polyethylene glycol diester plasticizer is in a range of from 1 to 20 wt %, preferably 2 to 10 wt %, in each case based on the weight of the pigmented latex composition. Suitable polyethylene glycol diester plasticizers are commercially available. The inventors have found that by using polyethylene glycol diester plasticizers the Tg of the binder polymer is suppressed more efficiently and the resulting composition consistently meets the requirements of ASTM C834, without the undesired environmental impact of other plasticizers.

The polyethylene glycol diester plasticizers may be used alone or in conjunction with other suitable plasticizers are known in the art depending on the application, for example benzoate, phthalate, or other ester plasticizers. Exemplary plasticizers include diethylene glycol dibenzoate, dipropylene glycol dibenzoate, butylbenzyl phthalate, N-n-butylbenzenesulfonamide, polyoxyethylene aryl ether, tributoxyethyl phosphate, and BENZOFLEX™ 9-88 benzoate ester plasticizer and TXIB™ 2,2,4-trimethyl-1,3-pentanediol diisobutyrate, both available from Eastman, Kingsport, Tenn.

### Dispersants

One or more dispersants are preferably included in the composition to produce a more uniform and stable distribution of the pigment particles. Exemplary dispersants are sold commercially as ACRYSOL™ RM-825 polyurethane rheology modifier (Rohm and Haas), TAMOL®851 sodium polymethacrylate (Dow Chemical), and DAXAD™ 30 sodium polymethacrylate (Dow Chemical).

### Other Ingredients

The pigmented compositions, particularly caulk or mastic compositions, of the invention may be adapted for use in a variety of specific applications, and generally exhibit excellent performance properties without the need for specialized ingredients such as propellants and foaming/blowing agents, e.g., low boiling hydrocarbons, halocarbons and halohydrocarbons, or polyphosphoric acids or salts thereof, as have been used in some specialized compositions. Drying oils and waxes are also not required. Thus, in some embodiments any or all of these other ingredients may be excluded from the inventive caulk or mastic.

The aqueous caulk or mastic compositions may be prepared by techniques which are well known in the art. For example, the aqueous polymer binder (VAE dispersion) is added directly to a kettle, followed by additional ingredients and, lastly, by the pigment. Mixing may be done in a high shear mixer with a sweep arm designed to pull the high viscosity sealant into the center of the mixer, or in a planetary mixer, with or without a high-speed disperser blade. After all ingredients are added, the composition is allowed to mix under a vacuum of 750 mm Hg or lower to remove entrapped air from the final product.

Typically, the caulks and mastics may have pigment to VAE binder (solids weight) ratios of at least 0.04, or at least 0.1, or at least 0.2. Typically, the ratio will be at most 4.0.

To enable improved adhesion, especially to glass, the caulks and sealants may comprise one or more organosilane adhesion promoter in amounts ranging from 0.001 wt % or 0.01 wt % to 0.5 wt %, 1.0 wt % or 5 wt %, based on the total composition.

Suitable organosilanes may include, for example, any hydrolysable or alkoxy functional organosilanes, such as, for example, trialkoxysilanes; aminoalkylsilanes or aminoalkoxysilanes, such as γ-aminopropyl triethoxysilane and N-(dimethoxymethylsilylisobutyl)ethylenediamine; epoxy functional alkoxysilanes, such as glycidylpropoxymethyl dimethoxysilane, γ-glycidoxypropyl-methyl-diethoxysilane, γ-glycidoxypropyl trimethoxysilane, and β-(3,4-epoxycycyclohexyl)ethyl trimethoxysilane: and γ-mercaptoalkoxysilanes.

Solvents may be added to improve tooling during use, increase open time (storage stability), and to better disperse additives such as the silanes. Suitable solvents may include, for example, mineral spirits, turpentine, mineral oil, and (poly)alkylene glycols.

The compositions of the present invention may also include other additives conventionally employed in caulks and sealants, such as, for example, free-thaw stabilizers, drying oils, biocides, rheology modifiers or thickeners such as cellulosics, kaolin, polyurethane thickeners, antifoamants, colorants, waxes and anti-oxidants.

The compositions of the present invention are suitable for uses including caulks and mastics, such as by applying the caulk and mastic to a substrate from a cartridge and allowing it to dry. Caulks and mastics can be applied to various substrates including wood, glass, metal, masonry, vinyl, brick, concrete block, fiber cement, gypsum, stone, tile and asphalt. Uses may include caulking and sealing windows, doors, fixtures, paneling, molding, finished walls and ceilings, and any gap, seam or joint therein or between substrate pieces, such as in tilt-up construction and chinking applications.

### Mastics

Mastics according to the invention include VAE binder having the compositions and characteristics described above, preferably free of APE surfactants and phosphate ester surfactants, and include polyethylene glycol diester plasticizers. The mastics according to the invention provide excellent strength, flexibility and workability, as well as rapid cure rates.

Preparation of the mastics may be according to formulation principles generally known in the art. In general, the mastics are aqueous formulations having a solids content of at least 60 wt %. The solids content is typically at most 75 wt %, more typically at most 70 wt %.

Kaolin and/or calcium carbonate are typical pigments, but others may be used instead or in addition to these. For example, calcium carbonate may constitute most of the pigment, with a clay being added at a 2-3 wt % level based on total mastic formulation weight. Thixotroping agents such as magnesium aluminum silicates or hydroxyethyl cellulose may be included in small amounts, for example at about 0.5-3 wt %. In total, the pigments will typically constitute at least 30 wt %, or at least 33 wt %, or at least 36 wt % of the mastic composition, and typically constitute at most 50 wt % of the composition, or at most 47 wt %, or at most 44 wt %. The VAE binder (solids weight)) will typically constitute at least 10 wt %, or at least 13 wt %, or at least 16 wt % of the mastic composition, and typically constitutes at most 30 wt % of the composition, or at most 27 wt %, or at most 24 wt %. The weight ratio (solids weight) of pigment to VAE binder will typically be at least 1.3, or at least 1.5, or at least 1.7. The ratio will typically be at most 3.5, or at most 3.3, or at most 3.2.

To prepare the mastic compositions, the pigment is added as an aqueous pigment slurry and mixed with the polymer binder and the plasticizer, the other additives and water.

Application of a mastic composition to the substrate may be made with any of the usual devices known in the art, such as a brush, putty knife or caulking gun. Any support material may be coated, and typical suitable support materials include wire mesh or plastic scrim.

### Caulks

Caulks according to the invention include VAE binder having the compositions and characteristics described above, preferably free of APE surfactants and phosphate ester surfactants, and utilize a polyethylene glycol diester plasticizer. The caulks according to the invention provide excellent strength, flexibility and workability, as well as extension-recovery and barrier properties, while meeting the requirements of ASTM C834.

Preparation of the caulks may be according to formulation principles generally known in the art. In general, the caulks are aqueous formulations having a solids content typically of at least 75 wt %, more typically at least 80 wt %. The solids content is typically at most 95 wt %, more typically at most 90 wt %.

Kaolin and/or calcium carbonate are typical pigments, but others may be used instead or in addition. For example, calcium carbonate may constitute most of the pigment, with titanium dioxide being added at a 1-2 wt % level based on total caulk formulation weight. Thixotroping agents such as magnesium aluminum silicates or hydroxyethyl cellulose may be included in small amounts, for example at about 0.5-3 wt %. In total, the pigments will typically constitute at least 30 wt %, or at least 33 wt %, or at least 36 wt % of the caulk composition, and typically constitute at most 50 wt % of the composition, or at most 47 wt %, or at most 44 wt %. The VAE binder (solids weight) will typically constitute at least 10 wt %, or at least 13 wt %, or at least 16 wt % of the caulk composition, and typically constitutes at most 30 wt % of the composition, or at most 27 wt %, or at most 24 wt %. The weight ratio (solids weight) of pigment to VAE binder will typically be at least 1.3, or at least 1.5, or at least 1.7. The ratio will typically be at most 2.5, or at most 2.3, or at most 2.1.

To prepare the caulk compositions, the pigment is added as an aqueous pigment slurry and mixed with the polymer binder and the plasticizer, the other additives and water.

Application of caulk composition to the substrate may be made with any of the usual devices known in the art, such as by brush, putty knife or caulking gun. Any support material may be coated, and typical suitable support materials include wire mesh or plastic scrim.

### EXAMPLES

Glossary:

Benzofiex® 50 benzoate ester plasticizer (Eastman, Kingsport, Tenn.)

Drikalite® Ca carbonate (Imerys Performance Minerals, Roswell, Ga.)

BYKM 024 silicone defoamer (BYK Additives and Instruments, Wallingford, Conn.)

Natrosol™ 250 HHR hydroxy ethyl cellulose (HEC) thickener (Ashland Specialty Chemicals Co., Dublin, Ohio)

Rhodoline® 3500 wetting and dispersing agent (Solvay Novecare, Cranbury, N.J.)

Tamol® 851 sodium polymethacrylate dispersant (Dow Chemical, Midland, Mich.)

PLASTHALL® 114 polyethylene glycol diester plasticizer (Hallstar Corporation, Chicago, Ill.)

Ti-Pure™ R-706 titanium dioxide (DuPont, Wilmington, Del.)

Vinnapas® EF 575 VAE copolymer dispersion (Wacker Chemical Corporation, Adrian, Mich.)

CAULK APPLICATIONS

Two comparative caulk formulations (designated as C1 and C2) were prepared and evaluated in comparison with a caulk formulation (S1) according to the present invention. Comparative caulks C1 and C2 were made using a standard plasticizer in the industry: Benzofiex™ 50, a benzoate ester plasticizer available from Eastman Chemical Company, Kingston, Tex. The inventive caulk formulation (S1) was made using PLASTHALL® 114, a polyethylene glycol diester plasticizer from Hallstar Corporation, Chicago, Ill.

The comparative caulks (C1 and C2) and the inventive caulk (S1) were made with a standard commercially available VAE dispersion, VINNAPAS® EF 575, available from Wacker Chemical Corporation, Adrian, Mich. VINNAPAS® EF 575 is an APE-free VAE binder dispersion in which the binder polymer does not include carboxylic acid monomer units.

The inventive caulk formulation was prepared utilizing a centrifugal mixer to make a 500 g batch. The following components were added to the mix container and hand blended after each addition: 26.3 g PLASTHALL®114 plasticizer, 4.2 g propylene glycol, 5.3 g Rhodoline® 3500 surfactant, 5.3 g Tamol®851, 0.9 g BYK™ 024 defoamer and 3.5 g Natrosol™ 250 HHR hydroxy ethyl cellulose (HEC) thickener. After combining these ingredients, the material was mixed for 1 minute at 1200 rpm. Then, 175.0 g VINNAPAS® EF 575 was added, and the batch was mixed for 1 minute at 1200 rpm. Half of the Drikalite® calcium carbonate, 125.5 g, was incorporated into the mix for 1 minute at 1200 rpm. The remaining 125.5 g of calcium carbonate and 5.3 g Ti-Pure™ R706 titanium dioxide was incorporated for 1 minute at 1200 rpm. Any remaining filler agglomerates were broken up by hand, and the batch was mixed for 2 minutes at 1600 rpm. After initially dispersing the filler, the batch was allowed to sit for 5-10 minutes to allow the HEC to swell. The batch was then mixed in 2-minute intervals at 1600 rpm until smooth. In between each mix step, the material was evaluated for lumps and temperature. The temperature should not exceed 49 C (120 F). Once the material was smooth, 14.1 g water and 0.4 g ammonia were added to the blend and followed by mixing for 2 minutes at 1600 rpm. Next, 8.3 g white mineral oil and 0.5 g glycidyloxy-propyltrimethoxy silane were premixed by hand with a tongue depressor and added to the batch followed by mixing for 3 minutes at 1600 rpm. The material was visually evaluated for lumps and mixing continued at intervals for 3 minutes at 1600 rpm until smooth. The temperature was maintained below 49 C (120 F).

The formulation and physical properties for the inventive caulk formulation (S1) is shown in Table 1 below.

TABLE 1
CAULK S1

| Ingredients | Wt. % |
|---|---|
| PLASTHALL ® 114 | 5.25 |
| Propylene Glycol | 0.84 |
| Rhodoline ® 3500 | 1.06 |
| Tamol ® 851 | 1.06 |
| BYK ™ 024 | 0.17 |
| Natrosol ™ 250 HHR | 0.70 |
| Vinnapas ® EF 575 | 35.00 |
| Drikalite ® | 50.21 |
| Ti-Pure ™ R706 | 1.05 |
| Water | 2.82 |
| Ammonia | 0.08 |
| White Mineral Oil | 1.66 |
| Glycidyloxypropyltrimethoxysilane | 0.10 |

The comparative caulk formulations (C1 and C2) were prepared in a manner similar to the inventive caulk formulation (S1) as described above. The formulations and physical properties of the comparative caulk formulations (C1 and C2) are shown in TABLES 2 and 3 below:

TABLE 2
CAULK C1

| Ingredients | Wt. % |
|---|---|
| Benzoflex ® 50 | 9.44 |
| Propylene Glycol | 0.82 |
| Rhodoline ® 3500 | 1.92 |
| Tamol ® 851 | 1.01 |
| BYK ™ 024 | 0.18 |
| Natrosol ™ 250 HHR | 0.95 |
| Vinnapas ® EF 575 | 28.60 |
| Drikalite ® | 49.34 |
| Ti-Pure ™ R706 | 1.00 |
| Water | 5.23 |
| Ammonia | 0.08 |
| White Mineral Oil | 1.32 |
| Glycidyloxypropyltrimethoxysilane | 0.10 |

TABLE 3
CAULK C2

| Ingredients | Wt. % |
|---|---|
| Benzoflex ® 50 | 10.03 |
| Propylene Glycol | 0.81 |
| Rhodoline ® 3500 | 1.04 |
| Tamol ® 851 | 1.01 |
| BYK ™ 024 | 0.16 |
| Natrosol ™ 250 HHR | 0.87 |
| Vinnapas ® EF 575 | 26.07 |
| Drikalite ® | 49.29 |
| Ti-Pure ™ R706 | 1.00 |
| Water | 8.65 |
| Ammonia | 0.07 |
| White Mineral Oil | 1.00 |
| Glycidyloxypropyltrimethoxysilane | 0.09 |

The following tests have been performed with the comparative formulations C1 and C2 and the inventive formulation S1:

Extrudability (g/s) according to the method of ASTM C1183.
Artificial wheathering (500 h exposure) according to the method of ASTM C732.
Volume Shrinkage (%) according to the method of ASTM C1241 (OP-Type).
Low Temperature Flexibility at −18 C according to the method of ASTM C734.
Extension Recovery (%) according to the method of ASTM C736.
Adhesion Loss (%) according to the method of ASTM C736.
Slump (mm) according to the method of ASTM D2202.

TABLE 4
Performance Testing

| | Caulk S1 | Caulk C1 | Caulk C2 |
|---|---|---|---|
| Extrudability (g/s) | 22.7 | pass | — |
| Artificial Weathering (500 h) | pass | pass | — |
| Volume Shrinkage (%) | 29 | 30 | — |
| Low Temperature Flexibility | pass | fail | fail |
| Extension Recovery (%) | 94 | 91 | — |
| Adhesion Loss (%) | 0 | 0 | — |
| Slump (mm) | 1.0 | 3.8 | 0.2 |

Performance testing of caulks C1, C2, and S1 gave the results shown in Table 4. As shown in Table 4, the inventive caulk (S1) was the only caulk to pass the ASTM C834 requirements. Although the invention is illustrated and described herein with reference to specific embodiments, the invention is not intended to be limited to the details shown. Rather, various modifications may be made in the details within the scope and range or equivalents of the claims without departing from the invention.

1-8. (canceled)

9. A pigmented latex composition, comprising:
wherein the pigmented latex composition has a solids content in the range from 60 wt % to 95 wt % comprising a vinyl acetate ethylene copolymer dispersion (VAE dispersion) and a plasticizer; and
wherein the pigmented latex composition comprises one or more plasticizers out of the group of polyethylene glycol diesters with 3 to 10 ethylene glycol units of C1-C10 alkyl carboxylic acids, wherein the carboxylic acids are identical or different and being branched or unbranched alkyl carboxylic acids.

10. The composition of claim 1, wherein the vinyl acetate ethylene copolymer is copolymerized with 60 wt % to 99 wt % vinyl acetate and with 1 wt % to 40 wt % ethylene, in each case based on the total weight of the monomer mixture, and the figures in wt % totaling 100 wt % in each case.

11. The composition of claim 1, wherein the vinyl acetate ethylene copolymer is copolymerized with 0.75 wt % to 5 wt % ethylenically unsaturated carboxylic acid monomer units, based on the total weight of the monomer mixture.

12. The composition of claim 1, wherein the composition comprises one or more plasticizers out of the group of polyethylene glycol diesters with 3 to 10 ethylene glycol units of C6-C10 alkyl carboxylic acids.

13. The composition of claim 1, wherein the composition comprises one or more plasticizers out of the group of polyethylene glycol diesters with 3 to 6 ethylene glycol units of C6-C10 alkyl carboxylic acids.

14. The composition of claim 1, wherein the composition comprises one or more plasticizers out of the group of polyethylene glycol diesters in an amount of 1 to 20 wt %, in each case based on the weight of the pigmented latex composition.

15. The composition of claim 1, wherein the pigmented latex composition is a mastic composition.

16. The composition of claim 1, wherein the pigmented latex composition is a caulk composition.
